(19) United States
(12) Patent Application Publication
(10) Pub. No.: US 2025/0314431 A1
(43) Pub. Date: Oct. 9, 2025

(54) HEAT STORAGE POWER GENERATION SYSTEM AND POWER GENERATION CONTROL SYSTEM

(71) Applicants: KABUSHIKI KAISHA TOSHIBA, Minato-ku, Tokyo (JP); TOSHIBA ENERGY SYSTEMS & SOLUTIONS CORPORATION, Kawasaki-shi, Kanagawa (JP)

(72) Inventors: Atsushi MATSUZAKI, Sagamihara Kanagawa (JP); Keiko SHIMIZU, Kawasaki Kanagawa (JP); Masakazu SHIRAKAWA, Yokohama Kanagawa (JP); Hiromutsu MIKI, Yokohama Kanagawa (JP); Toyohiro AKEBI, Inagi Tokyo (JP); Taufiq Hilal TAWAB, Kita Tokyo (JP); Takahiro MORI, Yokohama Kanagawa (JP); Hironori WATANABE, Yokohama Kanagawa (JP); Yusuke FUKAMACHI, Higashiyamato Tokyo (JP); Syuntaro ABE, Fuchu Tokyo (JP); Chikako IWAKI, Shinagawa Tokyo (JP); Takashi MAWATARI, Kawasaki Kanagawa (JP)

(73) Assignees: KABUSHIKI KAISHA TOSHIBA, Minato-ku, Tokyo (JP); TOSHIBA ENERGY SYSTEMS & SOLUTIONS CORPORATION, Kawasaki-shi, Kanagawa (JP)

(21) Appl. No.: 18/570,996

(22) PCT Filed: Nov. 30, 2021
(86) PCT No.: PCT/JP2021/043872

§ 371 Date: Oct. 2, 2024

(30) Foreign Application Priority Data
Jun. 17, 2021 (JP) 2021-101143

(51) Int. Cl. F28D 20/00

(52) U.S. Cl. CPC F28D 20/0034

(57) ABSTRACT

In one embodiment, a heat storage power generation system includes a heater configured to heat first heat transfer fluid. The system further includes a heat storage including a heat storage material heated by the first heat transfer fluid, and configured to heat second heat transfer fluid with heat stored in the heat storage material. The system further includes a power generator configured to generate electric power by using the second heat transfer fluid. The system further includes one or more temperature meters configured to measure internal temperature of the heat storage. The system further includes a power generation controller configured to control power generation performed by the power generator, based on the internal temperature measured by the temperature meters.

### FIELD

Embodiments described herein relate to a heat storage power generation system and a power generation control system.

### BACKGROUND

Various heat storage power generation systems have been proposed. A heat storage power generation system includes a heat storage including a heat storage material, and a power generator configured to generate electric power by using heat stored in the heat storage material.

For example, technologies of managing the temperature of heat transfer fluid transferred from the heat storage to the power generator and technologies of setting the gradient of distribution of the internal temperature of the heat storage to a desired gradient have been proposed. In addition, technologies of managing the amount of energy that heats the heat storage material to a constant value by measuring the temperature of the heat transfer fluid upstream of the entrance of the heat storage and downstream of the exit thereof when the heat storage is operated in a heat storing mode have been proposed. Furthermore, technologies that the power generator generates electric power by using a steam turbine cycle when the heat storage is operated in a heat releasing mode have been proposed.

In the heat storing mode, the heat storage material in the heat storage is heated by some means, for example, the heat transfer fluid at high temperature. Then, as the temperature of the heat storage material increases, energy is stored in the heat storage. The heat transfer fluid at high temperature is produced by, for example, electric power generated by using natural energy. The electric power is surplus electric power that exceeds electric power needed by, for example, an electric power system.

In the heat releasing mode, the heat storage material in the heat storage releases heat to some means, for example, the heat transfer fluid at low temperature. The heat transfer fluid at low temperature is heated by receiving thermal energy from the heat storage material. Accordingly, thermal energy in the heat storage material decreases. The heat transfer fluid heated in the heat storage is transferred to the power generator and supplies thermal energy to the steam turbine cycle in the power generator. The power generator generates electric power by using the thermal energy.

### BRIEF DESCRIPTION OF THE DRAWINGS

FIG. 1 is a schematic diagram illustrating the configuration of a heat storage power generation system of a first embodiment;

FIG. 2 is a schematic diagram illustrating disposition of temperature meters of the first embodiment;

FIGS. 3A to 3C are schematic diagrams for description of internal temperature Ts(xa, tk) of a heat storage of the first embodiment;

FIGS. 4A to 4C are schematic diagrams for description of a stored thermal energy amount Eg(tk) of the heat storage of the first embodiment;

FIG. 5 is a diagram for description of operation of a power generation plan processor of the first embodiment;

FIG. 6 is a diagram for description of the relation between input energy Q(tk) and electric generator output y(tk) of a power generator of the first embodiment;

FIG. 7 is a diagram for description of an initial power generation plan of the first embodiment;

FIG. 8 is a diagram for description of energy calculation performed to develop a modified power generation plan of the first embodiment;

FIG. 9 is a diagram for description of ΔEg(tk) of the first embodiment;

FIG. 10 is a diagram for description of power generation plan development in a case of ΔEg(tk)=0;

FIG. 11 is a diagram for description of a modified power generation plan (2);

FIG. 12 is a flowchart illustrating the process of developing the modified power generation plan (2);

FIG. 13 is a diagram illustrating an objective function and the like for developing a modified power generation plan (3) by solving an optimization problem;

FIG. 14 is a flowchart illustrating the process of developing the modified power generation plan (3) by solving an optimization problem;

FIG. 15 is a diagram for description of power generation plan development in a case of ΔEg(tk)<0;

FIG. 16 is another diagram for description of power generation plan development in a case of ΔEg(tk)<0;

FIG. 17 is a diagram for description of power generation plan development in a case of ΔEg(tk)>0;

FIG. 18 is another diagram for description of power generation plan development in a case of ΔEg(tk)>0;

FIG. 19 is a graph for description of interpolation processing (linear interpolation) of a first modification of the first embodiment; and

FIG. 20 is a graph for description of interpolation processing (spline interpolation) of a second modification of the first embodiment.

### DETAILED DESCRIPTION

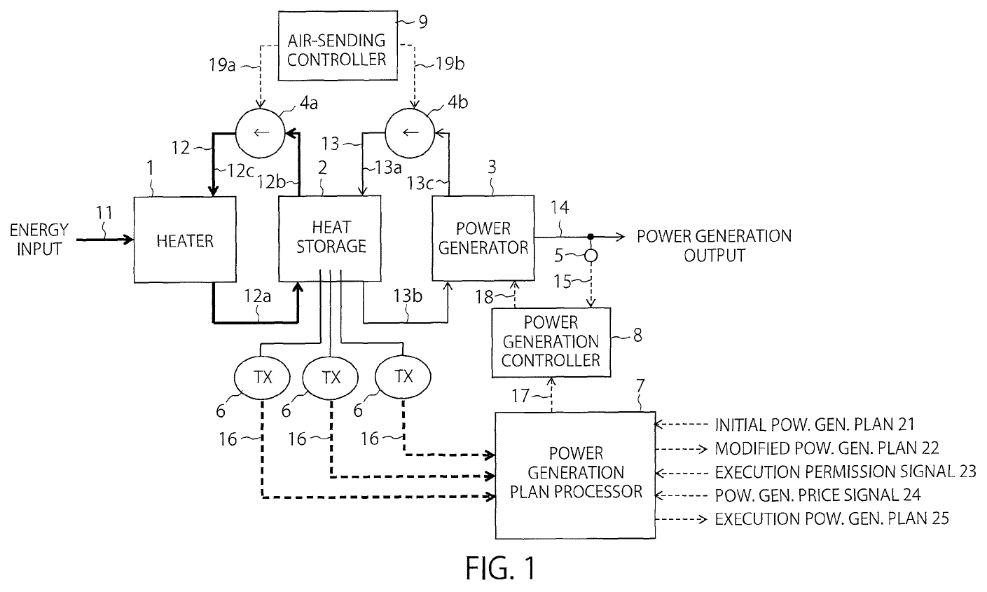

Embodiments will now be explained with reference to the accompanying drawings. In FIGS. 1 to 20, identical components are denoted by the same reference sign and duplicate description thereof is omitted.

However, with the above-described technologies, it is not possible to control operation of a power generator while taking the state of a heat storage into consideration. It is conceivable that, taking the state of the heat storage into consideration to control operation of the power generator, it is possible to suitably operate the heat storage and the power generator.

In one embodiment, a heat storage power generation system includes a heater configured to heat first heat transfer fluid. The system further includes a heat storage including a heat storage material heated by the first heat transfer fluid, and configured to heat second heat transfer fluid with heat stored in the heat storage material. The system further includes a power generator configured to generate electric power by using the second heat transfer fluid. The system further includes one or more temperature meters configured to measure internal temperature of the heat storage. The system further includes a power generation controller configured to control power generation performed by the power generator, based on the internal temperature measured by the temperature meters.

### First Embodiment

### [A] Overall Configuration

FIG. 1 is a schematic diagram illustrating the configuration of a heat storage power generation system of a first embodiment.

The heat storage power generation system of the present embodiment includes a heater 1, a heat storage 2, a power generator 3, a first air sender 4a, a second air sender 4b, a power generation output meter 5, one or more temperature meters 6, a power generation plan processor 7, a power generation controller 8, and an air-sending controller 9. The power generation output meter 5, the temperature meters 6, the power generation plan processor 7, the power generation controller 8, and the air-sending controller 9 constitute a power generation control system that controls the heat storage power generation system of the present embodiment.

### [A-1] Heater 1

FIG. 1 illustrates energy input 11 to the heater 1. The heater 1 of the present embodiment receives electric power as the energy input 11 and converts the electric power into heat by using a heat generating source such as an electric heater. In addition, the heater 1 of the present embodiment heats heat transfer fluid 12c at low temperature by using the heat and generates heat transfer fluid 12a at high temperature. The heater 1 may convert energy other than electric power into heat. For example, the heat transfer fluids denoted by reference signs 12a and 12c are examples of first heat transfer fluid.

The power generation control system of the present embodiment includes a heating controller (not illustrated) configured to control operation of the heater 1. The heating controller controls operation of the heater 1 so that, for example, the amount of energy consumption by the heater 1 or the temperature of the heat transfer fluid 12a becomes equal to a desired value.

[a-2] Heat Storage 2

The heat storage 2 includes a heat storage material (not illustrated) and can store heat in the heat storage material. The heat storage material is, for example, a crushed rock. The heat storage 2 of the present embodiment is operated in a heat storing mode or a heat releasing mode.

In the heat storing mode, the heat transfer fluid 12a at high temperature enters the heat storage 2. The heat storage material in the heat storage 2 is heated by the heat transfer fluid 12a. Accordingly, the temperature of the heat storage material rises. Simultaneously, the temperature of the heat transfer fluid 12a falls, and the heat transfer fluid 12a becomes heat transfer fluid 12b at low temperature and is discharged to the outside of the heat storage 2. In this manner, in the heat storing mode, thermal energy is stored in the heat storage 2 as the temperature of the heat storage material in the heat storage 2 rises.

In the heat releasing mode, heat transfer fluid 13a at low temperature enters the heat storage 2. Heat of the heat storage material in the heat storage 2 is absorbed by the heat transfer fluid 13a, in other words, the heat storage material releases heat to the heat transfer fluid 13a. Accordingly, the temperature of the heat storage material falls. Simultaneously, the temperature of the heat transfer fluid 13a rises, and the heat transfer fluid 13a becomes heat transfer fluid 13b at high temperature and is discharged to the outside of the heat storage 2. In this manner, in the heat releasing mode, the temperature of the heat storage material falls as the heat storage material in the heat storage 2 discharges thermal energy. For example, the heat transfer fluids denoted by reference signs 13a and 13b are examples of second heat transfer fluid.

The heat transfer fluid 12a flows from the lower side to the upper side in the heat storage 2 in illustration of FIG. 1, but in reality, does not necessarily need to flow from the lower side to the upper side and may flow, for example, from the uppers side to the lower side, from the right side to the left side, or from the left side to the right side. Similarly, the heat transfer fluid 13a flows from the uppers side to the lower side in the heat storage 2 in illustration of FIG. 1, but in reality, does not necessarily need to flow from the uppers side to the lower side and may flow, for example, from the lower side to the upper side, from the left side to the right side, or from the right side to the left side. FIG. 1 schematically illustrates the directions in which the heat transfer fluid 12a, the heat transfer fluid 13a, and the like flow.

[a-3] Power Generator 3

The power generator 3 generates electric power by using heat of the heat transfer fluid 13b at high temperature. The power generator 3 of the present embodiment includes a steam turbine, an electric generator, a heat exchanger, a steam condenser, and the like that constitute a steam turbine cycle. In this case, the power generator 3 generates steam from water with heat of the heat transfer fluid 13b, drives the steam turbine with the steam, drives the electric generator with the steam turbine, and generates electric power with the electric generator. FIG. 1 illustrates power generation output 14 from the power generator 3. Simultaneously, the temperature of the heat transfer fluid 13b falls, and the heat transfer fluid 13b becomes heat transfer fluid 13c at low temperature and is discharged to the outside of the power generator 3. The power generator 3 may generate electric power by using heat of the heat transfer fluid 13b in any other manner than the steam turbine cycle.

[a-4] First Air Sender 4a and Second Air Sender 4b

The first air sender 4a is used to cause the heat transfer fluid 12b discharged from the heat storage 2 to flow to the heater 1. In FIG. 1, heat transfer fluid flowing toward the first air sender 4a is denoted by reference sign 12b, and heat transfer fluid having passed through the first air sender 4a is denoted by reference sign 12c. The heat transfer fluid 12c enters the heater 1, is heated in the heater 1 to become the heat transfer fluid 12a at high temperature, and is discharged to the outside of the heater 1. In this manner, the first air sender 4a distributes (circulates) the heat transfer fluids 12a, 12b, and 12c between the heater 1 and the heat storage 2.

The second air sender 4b is used to cause the heat transfer fluid 13c discharged from the power generator 3 to flow to the heat storage 2. In FIG. 1, heat transfer fluid flowing toward the second air sender 4b is denoted by reference sign 13c, and heat transfer fluid having passed through the second air sender 4b is denoted by reference sign 13a. The heat transfer fluid 13a enters the heat storage 2, is heated in the heat storage 2 to become the heat transfer fluid 13b at high temperature, and is discharged to the outside of the heat storage 2. In this manner, the second air sender 4b distributes (circulates) the heat transfer fluids 13a, 13b, and 13c between the heat storage 2 and the power generator 3.

Depending on an operation purpose, the first air sender 4a causes the heat transfer fluid 12c to flow to the heater 1 at a constant flow rate or controls the flow rate of the heat transfer fluid 12c to a flow rate set value that varies. Similarly, depending on an operation purpose, the second air sender 4b causes the heat transfer fluid 13a to flow to the heat storage 2 at a constant flow rate or controls the flow rate of the heat transfer fluid 13a to a flow rate set value that varies. In any case, operation of the first air sender 4a and the second air sender 4b is controlled by the air-sending controller 9.

The heat storage power generation system of the present embodiment may include a single air sender configured to cause the heat transfer fluid 12c to flow to the heater 1 and cause the heat transfer fluid 13a to flow to the heat storage 2 instead of the first air sender 4a configured to cause the heat transfer fluid 12c to flow to the heater 1 and the second air sender 4b configured to cause the heat transfer fluid 13a to flow to the heat storage 2. In this case, the single air sender may include a switching device configured to switch between an air-sending path for the heat transfer fluid 12c and an air-sending path for the heat transfer fluid 13a.

[a-5] Power Generation Output Meter 5

The power generation output meter 5 measures the power generation output 14 from the power generator 3 and outputs a power generation output measurement signal 15 indicating a result of the measurement by the power generation output 14. The measurement result of the power generation output 14 is, for example, an MW value of electric power output from the power generator 3. The power generation output measurement signal 15 of the present embodiment is input to the power generation controller 8.

[a-6] Temperature Meter 6

Each temperature meter 6 measures the internal temperature of the heat storage 2 and outputs a temperature measurement signal 16 indicating a result of the measurement of the internal temperature. The internal temperature of the heat storage 2 is temperature inside the heat storage 2. Each temperature meter 6 of the present embodiment includes, for example, a temperature detection unit inserted into the heat storage material of the heat storage 2 and measures, as the internal temperature of the heat storage 2, the temperature of the heat storage material or the temperature of air or heat transfer fluid contained in the heat storage material. The measurement result of the internal temperature is for example, the value of the internal temperature measured by the heat storage 2. The temperature measurement signal 16 of the present embodiment is input to the power generation plan processor 7. In FIG. 1, three temperature measurement signals 16 are input from three temperature meters 6 to the power generation plan processor 7. The number of temperature meters 6 in the heat storage power generation system of the present embodiment may be other than three.

The heat storage power generation system of the present embodiment additionally includes a temperature meter configured to measure the temperature of the heat transfer fluid 13a upstream of the entrance of the heat storage 2, and a temperature meter configured to measure the temperature of the heat transfer fluid 13b downstream of the exit of the heat storage 2. Disposition of these temperature meters and the above-described temperature meters 6 will be described later in Section [B]. In the present embodiment, these temperature meters and the above-described temperature meters 6 measure temperature by using a thermocouple but may measure temperature by any other method (for example, an infrared measurement method).

[a-7] Power Generation Plan Processor 7

The power generation plan processor 7 develops a power generation plan for the power generator 3 based on the above-described internal temperature measured by each temperature meter 6. The power generation plan is a plan indicating in which manner power generation by the power generator 3 is to be performed. The power generation plan defines, for example, the MW value of electric power to be output from the power generator 3 at each time in the future. In this case, the power generation plan includes, for example, temporally sequential data of the MW value of electric power to be output from the power generator 3. The heat storage power generation system of the present embodiment operates the power generator 3 in accordance with the power generation plan developed by the power generation plan processor 7.

The power generation plan processor 7 of the present embodiment has, for example, functions as follows.

The power generation plan processor 7 determines a function representing distribution of the internal temperature of the heat storage 2 by using the temperature measurement signal 16 received from each temperature meter 6. The function can be expressed as a function Ts(xa, tk) of place xa and time tk as described later. The power generation plan processor 7 performs calculation that determines the function Ts(xa, tk). In the following description, the function Ts(xa, tk) is also referred to as “internal temperature Ts(xa, tk)” and “internal temperature distribution Ts(xa, tk)”. In the function Ts(xa, tk), xa and tk are also abstractly referred to as x and t.

The power generation plan processor 7 also calculates a thermal energy amount Eg(tk) in the heat storage 2, which is usable from time tk to a power generation end time tn in the heat releasing mode. This means that, when continuing power generation from time tk to the power generation end time tn, the power generator 3 can use the energy amount Eg(tk) among the total amount of energy in the heat storage 2 for power generation. Time tk is an example of a predetermined time. The energy amount Eg(tk) of the present embodiment is calculated by using the internal temperature distribution Ts(xa, tk) as described later. In the following description, the energy amount Eg(tk) is also referred to as “usable energy amount Eg(tk)” and “stored thermal energy amount Eg(tk)”.

In addition, at time tk, the power generation plan processor 7 outputs one or more modified power generation plans 22 that are executable power generation plans by using an initial power generation plan 21 that is an initial proposal of a power generation plan for time tk or later, the stored thermal energy amount Eg(tk), and a power generation price signal 24. At time tk, the power generation plan processor 7 may output a single modified power generation plan 22 or may simultaneously output a plurality of modified power generation plans 22. In the latter case, the power generation plan processor 7 selects one modified power generation plan 22 in accordance with an execution permission signal 23 that selects one of the plurality of modified power generation plans 22, and determines the modified power generation plan 22 as an execution power generation plan 25 for time tk or later. In the former case, the power generation plan processor 7 determines the above-described single modified power generation plan 22 as the execution power generation plan 25 for time tk or later. In this manner, the power generation plan processor 7 determines a power generation plan to be executed.

At time tk, the power generation plan processor 7 outputs a power generation command signal 17 based on the execution power generation plan 25. The power generation command signal 17 of the present embodiment indicates a set value of the power generation output 14 at time tk or later. The set value is determined in accordance with the execution power generation plan 25. The power generation command signal 17 is input to the power generation controller 8.

Further details of functions of the power generation plan processor 7 of the present embodiment will be described later in Section [C].

[a-8] Power Generation Controller 8

The power generation controller 8 outputs a power generation control signal 18 to the power generator 3 to match the set value of the power generation output 14 indicated by the power generation command signal 17 and the measured value of the power generation output 14 indicated by the power generation output measurement signal 15. For example, in a case in which the measured value is higher than the set value, the power generation control signal 18 that decreases the power generation output 14 is output. In a case in which the measured value is lower than the set value, the power generation control signal 18 that increases the power generation output 14 is output. In this manner, the power generation controller 8 controls power generation performed by the power generator 3.

To control the power generator 3 as described above, for example, the power generation controller 8 measures various process amounts that are internal information of the power generator 3, and operates various operation ends in the power generator 3 based on the process amounts. The process amounts are, for example, the pressure, temperature, and flow rate of heat transfer fluid, steam, and water. The operation ends are, for example, valves and pumps. The power generation controller 8 performs the control to match the set value and measured value of the power generation output 14 by, for example, proportional-integral-derivative (PID) control.

[a-9] Air-Sending Controller 9

The air-sending controller 9 controls operation of the first air sender 4a by using a first air-sending control signal 19a and controls operation of the second air sender 4b by using a second air-sending control signal 19b. The air-sending controller 9 can control distribution of the heat transfer fluids 12a to 12c between the heater 1 and the heat storage 2 by using the first air-sending control signal 19a and can control distribution of the heat transfer fluids 13a to 13c between the heat storage 2 and the power generator 3 by using the second air-sending control signal 19b.

### [B] Disposition of Temperature Meter 6

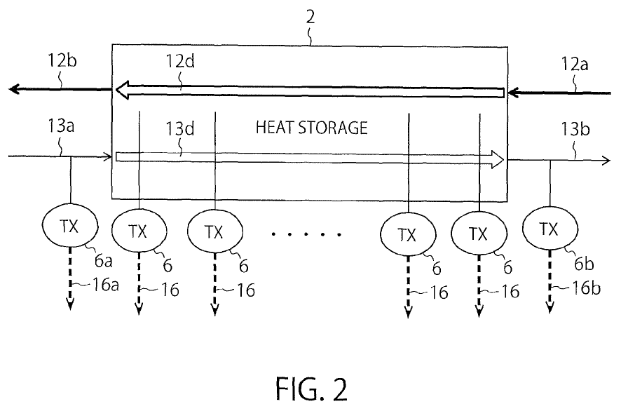

FIG. 2 is a schematic diagram illustrating disposition of the temperature meters 6 of the first embodiment.

FIG. 2 illustrates the above-described one or more temperature meters 6. Each temperature meter 6 measures the internal temperature of the heat storage 2 and outputs the temperature measurement signal 16 indicating a result of the measurement of the internal temperature to the power generation plan processor 7. FIG. 2 also illustrates a temperature meter 6a configured to measure the temperature of the heat transfer fluid 13a upstream of the entrance of the heat storage 2, and a temperature meter 6b configured to measure the temperature of the heat transfer fluid 13b downstream of the exit of the heat storage 2. The temperature meters 6a and 6b output temperature measurement signals 16a and 16b, respectively, indicating results of the measurement of the temperatures to the power generation plan processor 7. The power generation control system of the present embodiment also includes the temperature meters 6a and 6b.

FIG. 2 illustrates installation places of the temperature meters 6, 6a, and 6b. In a case in which the heat storage 2 illustrated in FIG. 2 is in the heat releasing mode, the heat transfer fluid 13a at low temperature enters the heat storage 2 from the left side, is heated by the heat storage 2 to become the heat transfer fluid 13b at high temperature, and is output to the right side of the heat storage 2. In FIG. 2, heat transfer fluid flowing inside the heat storage 2 in the heat releasing mode is denoted by reference sign 13d. In a case in which the heat storage 2 illustrated in FIG. 2 is in the heat storing mode, the heat transfer fluid 12a at high temperature enters the heat storage 2 from the right side, is cooled by the heat storage 2 to become the heat transfer fluid 12b at low temperature, and is output to the left side of the heat storage 2. In FIG. 2, heat transfer fluid flowing inside the heat storage 2 in the heat storing mode is denoted by reference sign 12d.

Each temperature meter 6 of the present embodiment is used to measure the internal temperature of the heat storage 2 in the heat releasing mode. The internal temperature at a place in the heat storage 2 and the internal temperature at another place in the heat storage 2 typically have different values even at the same time. In other words, distribution of the internal temperature in the heat storage 2 is typically non-uniform. The temperature at places in the heat storage 2 changes from moment to moment as time elapses.

For this reason, in the heat storage power generation system of the present embodiment, the internal temperature of the heat storage 2 is desirably measured by the plurality of temperature meters 6. With an increased number of the temperature meters 6, it is possible to highly accurately measure distribution of the internal temperature in the heat storage 2. Calculation to be described later in Section [C] is desirably performed by using the internal temperature distribution Ts(xa, tk) that is highly accurate. For this reason, the heat storage power generation system of the present embodiment desirably includes a large number such as 20 to 100 of temperature meters 6.

In FIG. 2, the plurality of temperature meters 6 are disposed alongside in the flowing direction of the heat transfer fluid 13d, in other words, disposed alongside each other in the right-left direction. In a case in which an x direction is defined to be the direction from the left side to the right side in FIG. 2, only one temperature meter 6 is disposed at one x coordinate.

However, the temperature meters 6 may be disposed in a manner different from the disposition illustrated in FIG. 2. For example, two or more temperature meters 6 may be disposed at shifted installation places at one x coordinate. This makes it possible to measure not only one-dimensional internal temperature distribution in the x direction but also two-dimensional or three-dimensional internal temperature distribution. For example, in a case in which a y direction and a z direction are defined to be two directions orthogonal to the x direction, it is possible to measure three-dimensional internal temperature distribution by disposing the above-described plurality of temperature meters 6 in a three-dimensional array in the x, y, and z directions. The x, y, and z directions are, for example, the lateral direction, the longitudinal direction, and the depth direction in the heat storage 2.

The installation place of each temperature meter 6 in Section [B] means the installation place of the temperature detection unit of the temperature meter 6. For example, in a case in which a temperature meter 6 detects the internal temperature of the heat storage 2 at the position of a terminal, the installation place of the temperature meter 6 means the position of the terminal. This is the same for the temperature meters 6a and 6b.

### [C] Function of Power Generation Plan Processor 7

### [C-1] Internal Temperature Ts(Xa, Tk)

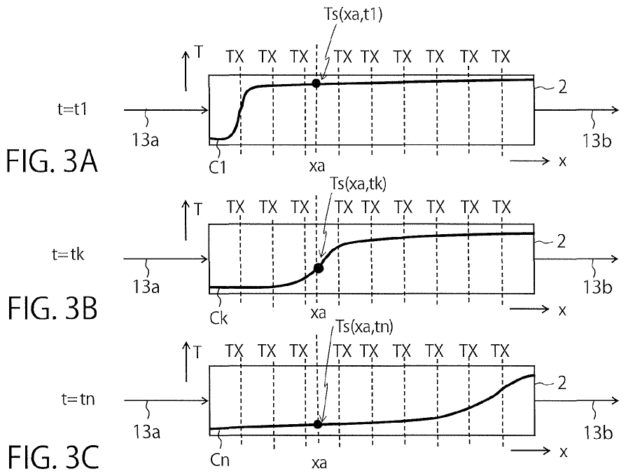

FIGS. 3A to 3C are schematic diagrams for description of the internal temperature Ts(xa, tk) of the heat storage 2 of the first embodiment.

FIG. 3A illustrates distribution of the internal temperature of the heat storage 2 at power generation start time (heat-releasing start time) t1 in the heat releasing mode. The graph illustrated in the heat storage 2 illustrates the relation between a place x in the lateral direction in the heat storage 2 and the internal temperature T of the heat storage 2. In FIG. 3A, the internal temperature T at time t=t1 and place x=xa is expressed as Ts(xa, t1). In addition, a curve of the internal temperature Ts(xa, t1) is expressed as C1 in FIG. 3A.

Similarly, FIG. 3B illustrates distribution of the internal temperature of the heat storage 2 at time tk in the heat releasing mode, and FIG. 3C illustrates distribution of the internal temperature of the heat storage 2 at power generation end time (heat-releasing end time) tn in the heat releasing mode. In this manner, FIGS. 3A to 3C illustrate temporal change of the internal temperature of the heat storage 2 in the heat releasing mode. Additional characters 1, k, and n in time t1, tk, and tn are integers that satisfy the relation of 1≤k≤n. In FIGS. 3B and 3C, the internal temperature T at time t=tk and place x=xa is expressed as Ts(xa, tk), and the internal temperature T at time t=tn and place x=xa is expressed as Ts(xa, tn). In addition, a curve of the internal temperature Ts(xa, tk) is expressed as Ck and a curve of the internal temperature Ts(xa, tn) is expressed as Cn in FIGS. 3B and 3C.

The power generation plan processor 7 receives, for example, the internal temperatures at M places in the heat storage 2 at time tk from M temperature meters 6 (M is an integer of two or larger). The power generation plan processor 7 can determine the internal temperature distribution Ts(xa, tk) at time t=tk by applying interpolation processing to the internal temperatures. In other words, the power generation plan processor 7 can determine a function (Ts(xa, tk)) representing distribution of the internal temperature of the heat storage 2 as a function of place xa and time tk. This makes it possible to accurately determine the internal temperature of the heat storage 2. Examples of the interpolation processing will be described later. The power generation plan processor 7 may determine the internal temperature distribution Ts(xa, tk) at time t=tk irrespective of interpolation processing.

The internal temperature of the heat storage 2 falls as the heat storage 2 is operated in the heat releasing mode. Along with the fall of the internal temperature of the heat storage 2, the temperature of the heat transfer fluid 13b output from the heat storage 2 falls as well. When the temperature of the heat transfer fluid 13b output from the heat storage 2 is lower than a certain value, the temperature of the heat transfer fluid 13b is not suitable for power generation at the power generator 3. Time tn of the present embodiment is a time right before the temperature of the heat transfer fluid 13b becomes not suitable for power generation. The internal temperature distribution Ts(x, tn) at time tn can be determined by analysis or test operation in advance. The power generation plan processor 7 of the present embodiment stores the internal temperature distribution Ts(x, tn) at time tn in advance.

### [C-2] Stored Thermal Energy Amount Eg(Tk)

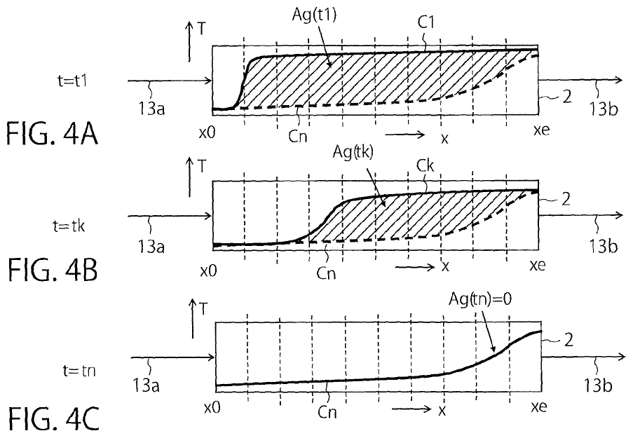

FIGS. 4A to 4C are schematic diagrams for description of the stored thermal energy amount Eg(tk) of the heat storage 2 of the first embodiment.

FIG. 4A illustrates the curve C1 of the internal temperature distribution Ts(x, t1) at time t1 together with the curve Cn of the internal temperature distribution Ts(x, tn) at time tn. FIG. 4A also illustrates an integration value Ag(t1) of the internal temperature difference of Ts(x, t1)−Ts(x, tn) at time t1. The integration value Ag(t1) corresponds to the area between the curves C1 and Cn from place x0 at the entrance of the heat storage 2 to place xe at the exit of the heat storage 2. The integration value Ag(t1) is given by Expression (1) below.

$$Ag ( t 1 ) = {\int }_{x 0}^{xe} \{ T s ( x , t 1 ) - T s ( x , tn ) \} dx \qquad ( 1 )$$

FIG. 4B illustrates the curve Ck of the internal temperature distribution Ts(x, tk) at time tk together with the curve Cn of the internal temperature distribution Ts(x, tn) at time tn. FIG. 4B also illustrates an integration value Ag(tk) of the internal temperature difference of Ts(x, tk)−Ts(x, tn) at time tk. The integration value Ag(tk) corresponds to the area between the curves Ck and Cn from place x0 at the entrance of the heat storage 2 to place xe at the exit of the heat storage 2. The integration value Ag(tk) is given by Expression (2) below.

$$Ag ( tk ) = {\int }_{x 0}^{xe} \{ T s ( x , tk ) - T s ( x , tn ) \} dx \qquad ( 2 )$$

FIG. 4C illustrates the curve Cn of the internal temperature distribution Ts(x, tn) at time tn. An integration value Ag(tn) of the internal temperature difference of Ts(x, tn)−Ts(x, tn) at time tn is zero (Ag(tn)=0).

Assume that the integration value Ag(t1) is calculated by Expression (1) at time t1. When the heat capacity and mass of the heat storage material in the heat storage 2 are Cpm [KJ/Kg/° C.] and W [kg], the stored thermal energy amount Eg(t1) at time t1 is given by Expression (3) below.

$$E g ( t 1 ) = Ag ( t 1 ) * Cpm * W \qquad ( 3 )$$

Similarly, assume that the integration value Ag(tk) is calculated by Expression (2) at time tk. In this case, the stored thermal energy amount Eg(tk) at time tk is given by Expression (4) below.

$$E g ( tk ) = Ag ( tk ) * Cpm * W \qquad ( 4 )$$

The stored thermal energy amount Eg(tn) at time tn is zero (Eg(tn)=0).

For example, at optional time tk that satisfies t1≤tk≤tn, the power generation plan processor 7 can calculate the integration value Ag(tk) from the internal temperature distribution Ts(x, tn) by using Expression (2) and calculate the stored thermal energy amount Eg(tk) from the integration value Ag(tk) by using Expression (4). In the heat storage power generation system of the present embodiment, when the power generator 3 continues power generation from time tk to time tn, the energy amount Eg(tk) can be taken out of the heat storage 2. In addition, the power generation plan processor 7 can develop a power generation plan for time tk or later by using the stored thermal energy amount Eg(tk).

### [C-3] Power Generation Plan

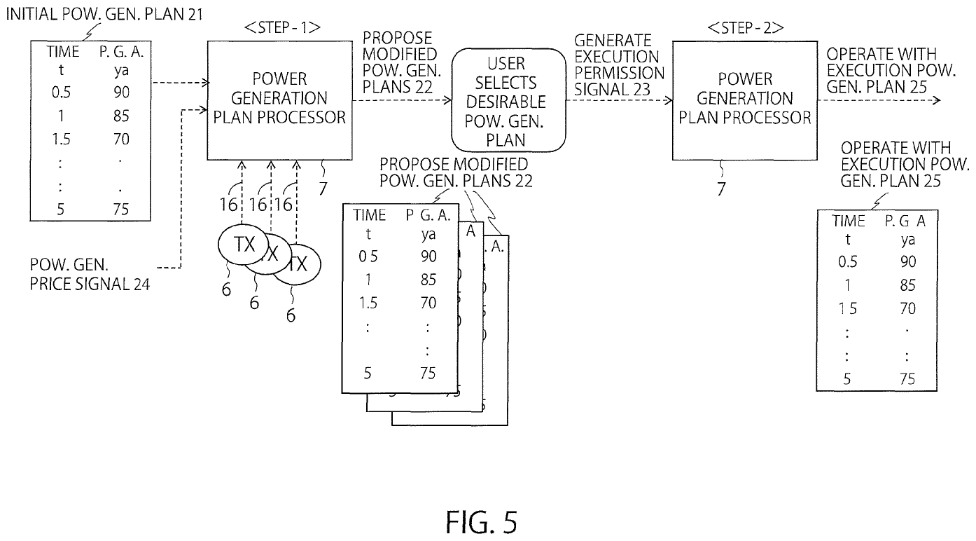

FIG. 5 is a diagram for description of operation of the power generation plan processor 7 of the first embodiment.

FIG. 5 illustrates the initial power generation plan 21, the power generation price signal 24, and the plurality of temperature measurement signals 16 input to the power generation plan processor 7. FIG. 5 also illustrates the one or more modified power generation plans 22, the execution permission signal 23, and the execution power generation plan 25. FIG. 5 illustrates a process that the power generation plan processor 7 develops the execution power generation plan 25 from the initial power generation plan 21.

At time tk, the power generation plan processor 7 outputs the one or more modified power generation plans 22 that are executable power generation plans by using the initial power generation plan 21 that is an initial proposal of a power generation plan for time tk or later, the stored thermal energy amount Eg(tk) calculated from each temperature measurement signal 16, and the power generation price signal 24 (step 1). At time tk, the power generation plan processor 7 may output a single modified power generation plan 22 or may simultaneously output a plurality of modified power generation plans 22.

In the latter case, for example, the power generation plan processor 7 displays (proposes) the plurality of modified power generation plans 22 on a user interface and receives, from a user, a selection operation that selects one of the plurality of modified power generation plans 22. When the user inputs such a selection operation on the user interface, the execution permission signal 23 that selects one of the plurality of modified power generation plans 22 is generated. The power generation plan processor 7 selects the one modified power generation plan 22 in accordance with the execution permission signal 23 and determines the modified power generation plan 22 as the execution power generation plan 25 for time tk or later. In the former case, the power generation plan processor 7 determines the above-described single modified power generation plan 22 as the execution power generation plan 25 for time tk or later. In this manner, the power generation plan processor 7 determines a power generation plan to be executed (step 2).

Further details of the process illustrated in FIG. 5 will be described below.

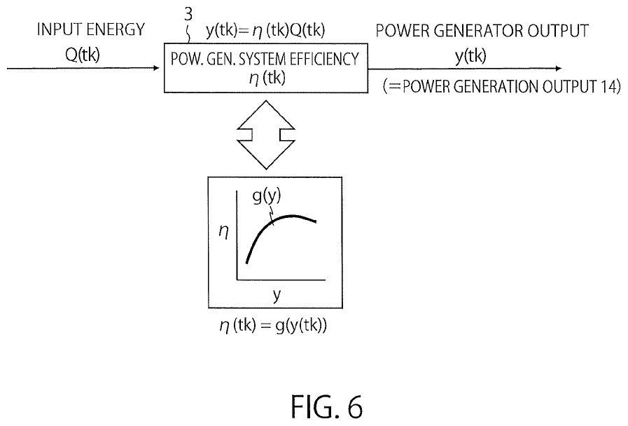

FIG. 6 is a diagram for description of the relation between input energy Q(tk) and electric generator output y(tk) of the power generator 3 of the first embodiment.

The graph illustrated in FIG. 6 indicates that power generation efficiency n can be expressed as a function of the electric generator output y. This means that once the electric generator output y(k) is determined, the power generation efficiency n(tk) can be determined in accordance with the electric generator output y(k). This relation can be expressed as Expression (5) below by using a function g.

$$η ( tk ) = g ( y ( tk ) ) \qquad ( 5 )$$

In the present embodiment, y corresponds to the power generation output 14 from the power generator 3, and n corresponds to power generation efficiency of the power generator 3.

When Q(tk) represents the amount of energy provided to the power generator 3 at time tk, the relation of Expression (6) below holds among Q(tk), y(tk) and n(tk).

$$y ( tk ) = η ( tk ) Q ( tk ) \qquad ( 6 )$$

Expression (6) corresponds to a definition formula of the power generation efficiency n. When the unit of y(tk) is [MW] and the unit of Q(tk) is [MW] in Expression (6), 0≤n(tk)<1 holds. The condition of n(tk)=1 means that all heat provided to the power generator 3 changes to electric power, which is not allowed by the second law of thermodynamics.

Assume that desirable electric generator output ya(tk) at time tk is provided. In this case, energy Qa(tk) needed to be provided to the power generator 3 is given by Expression (7) below from Expressions (5) and (6).

$$Q a ( tk ) = \frac{y a ( fk )}{η ( fk )} = \frac{y a ( fk )}{g ( y a ( fk ) )} \qquad ( 7 )$$

In Expression (7), Qa(tk) is expressed as the ratio of ya(tk) and g (ya(tk)), which indicates that Qa(tk) can be calculated from ya(tk).

The heat storage power generation system of the present embodiment includes a means for calculating n(tk) and Qa(tk) from ya(tk) when the value of the desirable electric generator output ya(tk) is input. The means is provided, for example, in the power generation plan processor 7.

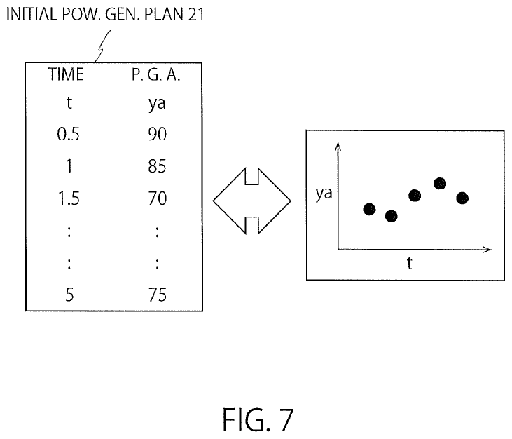

FIG. 7 is a diagram for description of the initial power generation plan 21 of the first embodiment.

The initial power generation plan 21 of the present embodiment is input to the power generation plan processor 7 from the outside of the power generation plan processor 7. The initial power generation plan 21 can be expressed by a numerical string including a plurality of times t(k+1), t(k+2), . . . , tm after time tk and desirable the electric generator output ya(t(k+1)), ya(t(k+2)), . . . , ya(tm) at the times (m is an integer that satisfies k<m≤n).

In the example illustrated in FIG. 7, t(k+1)=0.5 [hour], t(k+2)=1 [hour], . . . , tm=5 [hour], and ya(t(k+1))=90 [MW], ya(t(k+2))=85 [MW], . . . , ya(tm)=75 [MW]. The initial power generation plan 21 in the example includes a power generation plan for five hours from time tk.

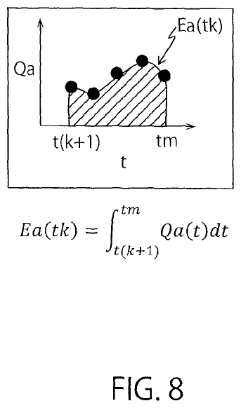

FIG. 8 is a diagram for description of energy calculation performed to develop a modified power generation plan 22 of the first embodiment.

The power generation plan processor 7 calculates necessary energy Qa(t(k+1)), Qa(t(k+2)), . . . , Qa(tm) at time t(k+1), t(k+2), . . . , tm by using the initial power generation plan 21 and Expression (7). The power generation plan processor 7 also calculates, by Expression (8) below, the sum Ea(tk) of energy necessary for obtaining the electric generator output ya(t(k+1)), ya(t(k+2)), . . . , ya(tm) of the initial power generation plan 21.

$$E a ( tk ) = {\int }_{t ( k + 1 )}^{tm} Q a ( t ) dt \qquad ( 8 )$$

The energy sum Ea(tk) corresponds to the sum of energy needed in power generation by the power generator 3 until time tm. Although the above-described stored thermal energy amount Eg(tk) indicates energy usable for power generation until the power generation end time tn, the energy sum Ea(tk) indicates energy needed in power generation until time tm. Hereinafter, the energy sum Ea(tk) is also referred to as “necessary energy amount Ea(tk)”.

The power generation plan processor 7 also calculates the difference ΔEg(tk) between the stored thermal energy amount Eg(tk) and the necessary energy amount Ea(tk) by Expression (9) below.

$$Δ Eg ( tk ) = Eg ( tk ) - E a ( tk ) \qquad ( 9 )$$

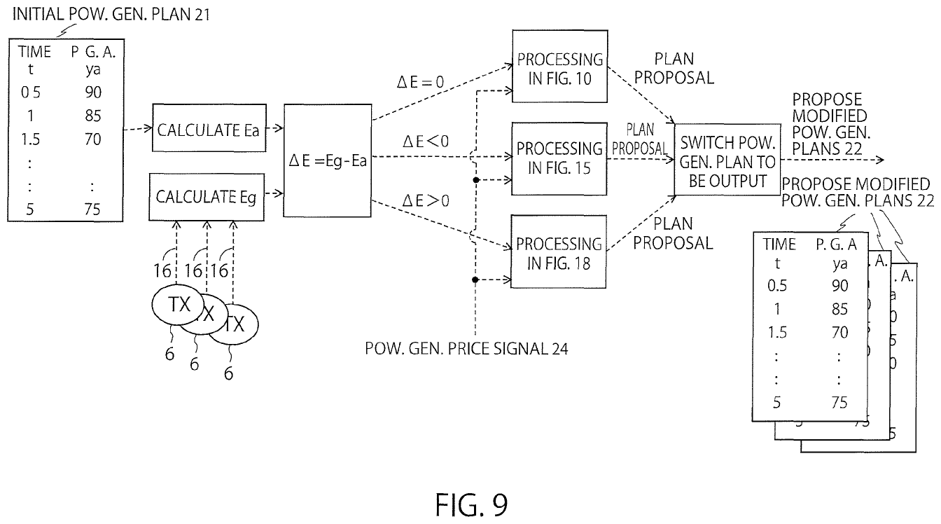

FIG. 9 is a diagram for description of ΔEg(tk) of the first embodiment.

The power generation plan processor 7 of the present embodiment develops one or more modified power generation plans 22 with ΔEg(tk) taken into consideration. The modified power generation plans 22 are proposed to the user on the user interface, for example. In this case, the user can select a desirable plan from among the modified power generation plans 22.

Specifically, as illustrated in FIG. 9, the power generation plan processor 7 performs classification into the case of ΔEg(tk)=0, the case of ΔEg(tk)<0, and the case of ΔEg(tk)>0 and executes different processing in accordance with each case. Details of the processing will be described below.

### [C-3-1] Case of ΔEg(Tk)=0

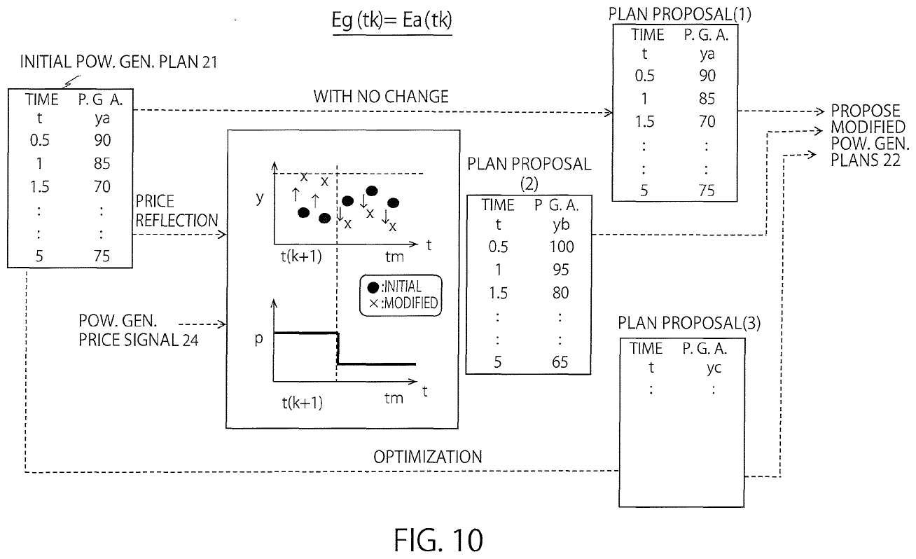

FIG. 10 is a diagram for description of power generation plan development in the case of ΔEg(tk)=0.

In the case of ΔEg(tk)=0, the stored thermal energy amount Eg(tk) is equal to the necessary energy amount Ea(tk). In this case, the power generation plan processor 7 outputs a modified power generation plan (1), a modified power generation plan (2), and a modified power generation plan (3) as the modified power generation plans 22. As illustrated in FIG. 10, the plans are also referred to as a plan proposal (1), a plan proposal (2) and a plan proposal (3), respectively.

### <Modified Power Generation Plan (1)>

The power generation plan processor 7 does not modify the initial power generation plan 21 but outputs the initial power generation plan 21 as the modified power generation plan (1) with no change. Accordingly, similarly to the initial power generation plan 21, the modified power generation plan (1) includes the electric generator output ya(t(k+1)), ya(t(k+2)), . . . , ya(tm) at time t(k+1), t(k+2), . . . , tm. The electric generator output is also referred to as “power generation amount”.

### <Modified Power Generation Plan (2)>

The power generation plan processor 7 develops the modified power generation plan (2) from the initial power generation plan 21 by modifying the initial power generation plan 21 by using the power generation price signal 24. As illustrated in FIG. 10, the power generation price signal 24 indicates a power generation price p at time t(k+1), t(k+2), . . . , tm. The power generation plan processor 7 develops the modified power generation plan (2) with which as large an amount of stored thermal energy amount (usable energy) Eg(tk) as possible is used and the profit of power generation is maximized. For example, in a case in which the power generation price is high in the first half of time t(k+1) to tm and low in the second half of time t(k+1) to tm, the electric generator output in the first half of time t(k+1) to tm is increased and the electric generator output in the second half of time t(k+1) to tm is decreased. The modified power generation plan (2) illustrated in FIG. 10 includes electric generator output yb(t(k+1)), yb(t(k+2)), . . . , yb(tm) at time t(k+1), t(k+2), . . . , tm.

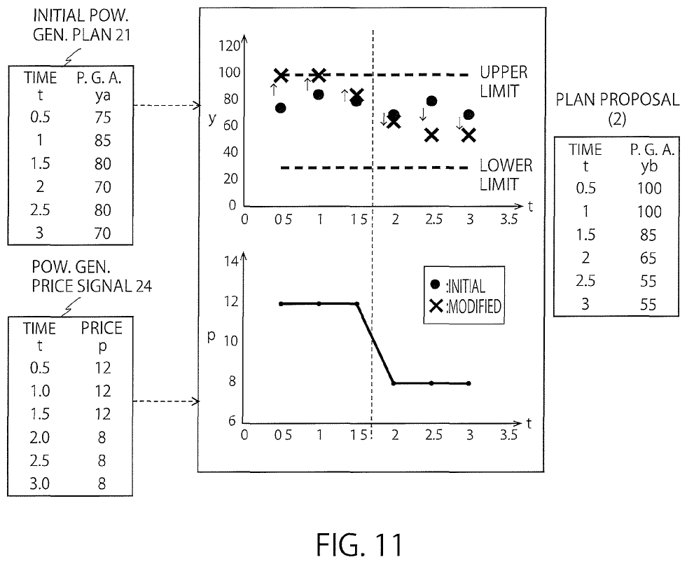

FIG. 11 is a diagram for description of the modified power generation plan (2).

FIG. 11 illustrates details of the initial power generation plan 21 and the modified power generation plan (2) as well as details of the power generation price signal 24. The power generation price signal 24 includes the power generation price p(t(k+1)), p(t(k+2)), . . . , p(tm) at time t(k+1), t(k+2), . . . , tm.

As described above, the power generation plan processor 7 develops the modified power generation plan (2) from the initial power generation plan 21 by modifying the initial power generation plan 21 by using the power generation price signal 24. Accordingly, the value of the power generation amount yb in the modified power generation plan (2) is changed from the value of the power generation amount ya in the initial power generation plan 21. FIG. 11 illustrates the modified power generation plan (2) obtained under constraints that a power generation upper limit value is 100 MW, a power generation lower limit value is 30 MW, and a power generation change rate is −20 MW/0.5 hours to +20 MW/0.5 hours.

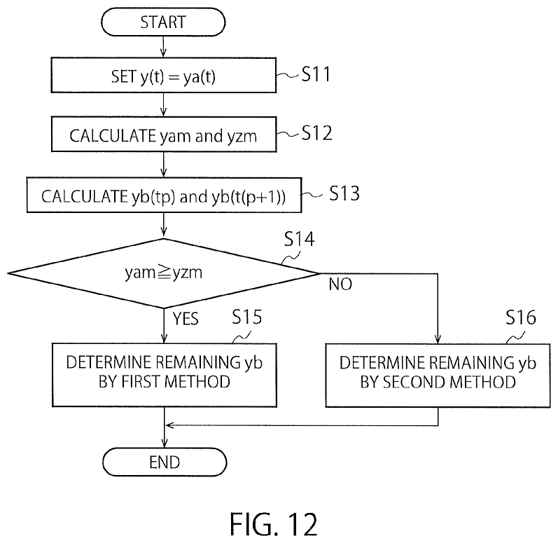

FIG. 12 is a flowchart illustrating the process of developing the modified power generation plan (2).

First, the initial power generation plan 21 is set with y(t)=ya(t) (step S11). Subsequently, an average value yam of ya and an average value yzm of the power generation upper limit value and the power generation lower limit value are calculated (step S12). Subsequently, the electric generator outputs yb(tp) and yb(t(p+1)) at times tp and t(p+1) at which the power generation price p is changed are calculated (step S13).

Subsequently, in the case of yam≥yzm (YES at step S14), the electric generator output yb for the remaining time is determined by a first method (step S15). In the first method, the electric generator output yb at a time earlier than time tp is the smaller one of “yb(tp)+20” and the power generation upper limit value, and the electric generator output yb at a time later than time t(p+1) is an equal division of the remaining energy.

In the case of yam<yzm (NO at step S14), the electric generator output yb for the remaining time is determined by a second method (step S16). In the second method, the electric generator output yb at a time later than time t(p+1) is the larger one of “yb(tp)−20” and the power generation lower limit value, and the electric generator output yb at a time earlier than time tp is an equal division of the remaining energy.

### <Modified Power Generation Plan (3)>

The power generation plan processor 7 modifies the initial power generation plan 21 by solving an optimization problem with the stored thermal energy amount Eg(tk) and develops the modified power generation plan (3) from the initial power generation plan 21. Specifically, the modified power generation plan (3) is calculated by being formulated and solved as an optimization problem by processing as follows. The modified power generation plan (3) illustrated in FIG. 10 includes electric generator output yc(t(k+1)), yc(t(k+2)), . . . , yc(tm) at time t(k+1), t(k+2), . . . , tm.

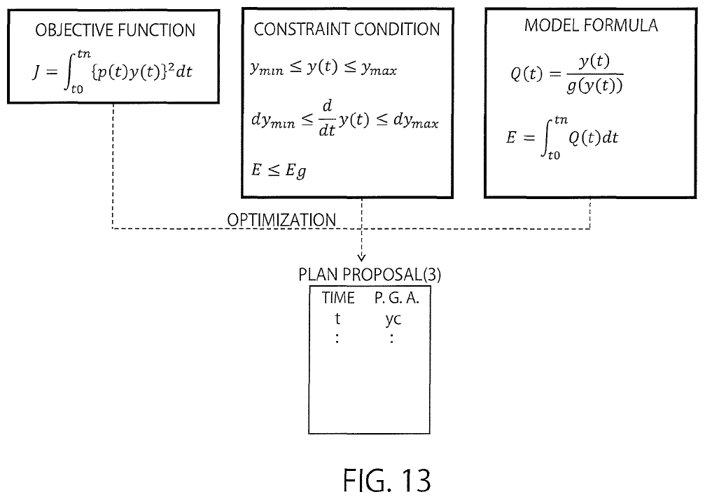

FIG. 13 is a diagram illustrating an objective function and the like for developing the modified power generation plan (3) by solving an optimization problem. FIG. 13 illustrates one objective function, three constraint conditions, and two model formulae that are used for the optimization problem.

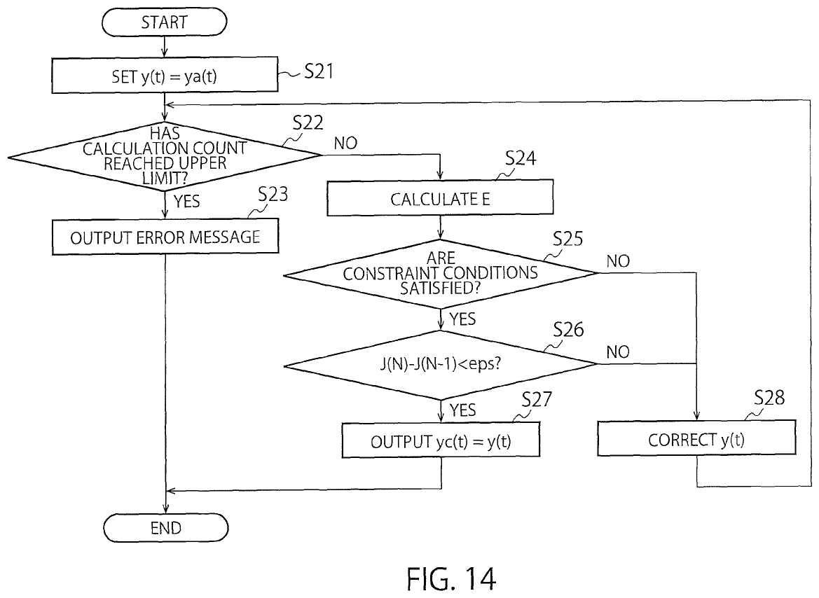

An objective function J illustrated in FIG. 13 is used to maximize a selling price. In the optimization problem, the power generation plan processor 7 performs calculation that maximizes the objective function J. In this case, it is possible to obtain an optimum solution of the optimization problem by performing iterative calculation illustrated in FIG. 14 without deviating the above-described three constraint conditions.

The first constraint condition indicates a condition that the electric generator output y varies between an upper limit value ymax and a lower limit value ymin. The second constraint condition indicates a condition that the change rate dy/dt of the electric generator output varies between an upper limit value dymax and a lower limit value dymin. The third constraint condition indicates a condition that energy E used for power generation by the power generator 3 is equal to or smaller than the stored thermal energy amount Eg. The first model formula indicates a relational expression related to the power generation efficiency n. The second model formula indicates a relational expression related to the energy E.

FIG. 14 is a flowchart illustrating the process of developing the modified power generation plan (3) by solving a optimization problem.

First, the initial power generation plan 21 is set with y(t)=ya(t) (step S21). Subsequently, whether a calculation count N has reached its upper limit is determined (step S22). When the determination at step S22 is “YES”, an error message that prompts ya(t) resetting is output because a desired power generation plan cannot be achieved (step S23).

When the determination at step S22 is “NO”, the energy E is calculated by performing simulation calculation for time t0 to tn by using the above-described two model formulae (step S24). Subsequently, whether y(t), dy(t)/dt, and E calculated at steps S21 to S24 satisfy the above-described three constraint conditions is determined (step S25).

When the determination at step S25 is “YES”, whether J(N)−J(N−1)<eps is satisfied is determined (step S26), where J(N) represents the N-th calculated objective function J. When the determination at step S26 is “YES”, y(t) calculated by using J(N) is set to yc(t) and the modified power generation plan (3) is output (step S27). When the determination at step S25 or S26 is “NO”, y(t) is corrected (step S28) and the process returns to step S22.

### [C-3-2] Case of ΔEg(Tk)<0

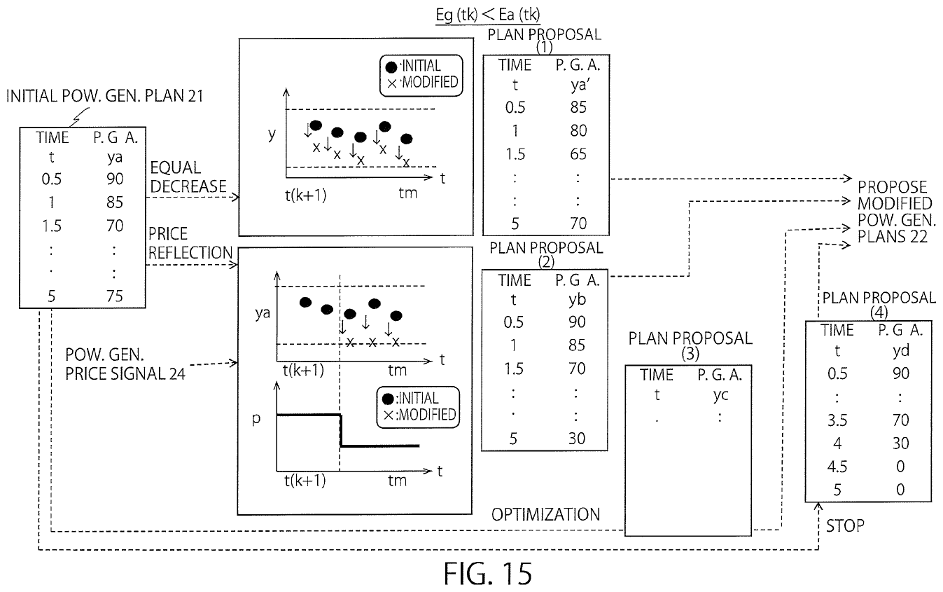

FIG. 15 is a diagram for description of power generation plan development in the case of ΔEg(tk)<0.

In the case of ΔEg(tk)<0, the stored thermal energy amount Eg(tk) is insufficient relative to the necessary energy amount Ea(tk). In this case, the power generation plan processor 7 outputs a modified power generation plan (1), a modified power generation plan (2), a modified power generation plan (3), and a modified power generation plan (4) as the modified power generation plans 22. As illustrated in FIG. 15, the plans are also referred to as a plan proposal (1), a plan proposal (2), a plan proposal (3), and a plan proposal (4), respectively.

### <Modified Power Generation Plan (1)>

The power generation plan processor 7 develops the modified power generation plan (1) from the initial power generation plan 21 by equally decreasing all electric generator outputs ya in the initial power generation plan 21 to modify the modified power generation plan (1). The modified power generation plan (1) illustrated in FIG. 15 includes electric generator output ya′ (t(k+1)), ya′ (t(k+2)), . . . , ya′ (tm) at time t(k+1), t(k+2), . . . , tm.

For example, in a case in which the initial power generation plan 21 includes 10 electric generator outputs ya(0.5), ya(1), ya(1.5), . . . , ya(5) for 10 times t=0.5, 1, 1.5, . . . , 5, each electric generator output ya′(t) of the modified power generation plan (1) is given by Expression (10) below.

$${ya}^{′} ( t ) = y a ( t ) + \frac{Δ Eg ( tk )}{10} \qquad ( 10 )$$

Specifically, ya′(0.5), ya′(1), ya′(1.5), . . . , ya′(5) are the sums of ya(0.5), ya(1), ya(1.5), . . . , ya(5), respectively, and ΔEg(tk)/10. Since ΔEg(tk) is negative in the case of FIG. 15, ya′(0.5), ya′(1), ya′(1.5), . . . , ya′(5) are smaller than ya(0.5), ya(1), ya(1.5), . . . , ya(5), respectively. This makes it possible to set the total power generation amount of ya′ (t(k+1))+ya′ (t(k+2)), . . . , +ya′ (tm) in the modified power generation plan (1) to be smaller than the total power generation amount of ya(t(k+1))+ya(t(k+2)), . . . , +ya(tm) in the initial power generation plan 21.

### <Modified Power Generation Plan (2)>

The power generation plan processor 7 develops the modified power generation plan (2) from the initial power generation plan 21 by modifying the initial power generation plan 21 by using the power generation price signal 24. The modified power generation plan (2) illustrated in FIG. 15 includes the electric generator output yb(t(k+1)), yb(t(k+2)), . . . , yb(tm) at time t(k+1), t(k+2), . . . , tm.

The modified power generation plan (2) in the case of ΔEg(tk)<0 can be calculated in the same manner as the modified power generation plan (2) in the case of ΔEg(tk)=0. However, the modified power generation plan (2) in the case of ΔEg(tk)<0 is calculated to satisfy a constraint condition that a necessary energy amount E(tk) (=Ec(tk)) calculated by using Expressions (7) and (8) is equal to the stored thermal energy amount Eg(tk). The constraint condition is expressed by Expression (11) below.

$$Δ Ec ( tk ) = E g ( tk ) - E c ( tk ) = 0 \qquad ( 11 )$$

For example, in a case in which the power generation price is high in the first half of time t(k+1) to tm and low in the second half of time t(k+1) to tm (refer to FIG. 15), the electric generator output in the first half of time t(k+1) to tm is not changed and the electric generator output in the second half of time t(k+1) to tm is decreased. This makes it possible to set the total power generation amount of yb(t(k+1))+yb(t(k+2)), . . . , +yb(tm) in the modified power generation plan (2) to be smaller than the total power generation amount of ya(t(k+1))+ya(t(k+2)), . . . , +ya(tm) in the initial power generation plan 21.

### <Modified Power Generation Plan (3)>

The power generation plan processor 7 develops the modified power generation plan (3) from the initial power generation plan 21 by solving an optimization problem with using the stored thermal energy amount Eg(tk) to modify the initial power generation plan 21. The modified power generation plan (3) illustrated in FIG. 15 includes electric generator output yc(t(k+1)), yc(t(k+2)), . . . , yc(tm) at time t(k+1), t(k+2), . . . , tm.

The modified power generation plan (3) in the case of ΔEg(tk)<0 can be calculated in the same manner as the modified power generation plan (3) in the case of ΔEg(tk)=0. This makes it possible to set the total power generation amount of yc(t(k+1))+yc(t(k+2)), . . . , +yc(tm) in the modified power generation plan (3) to be smaller than the total power generation amount of ya(t(k+1))+ya(t(k+2)), . . . , +ya(tm) in the initial power generation plan 21.

### <Modified Power Generation Plan (4)>

The power generation plan processor 7 develops the modified power generation plan (4) from the initial power generation plan 21 by modifying the initial power generation plan 21 to stop power generation at time when the power generation price p is low. The modified power generation plan (4) illustrated in FIG. 15 includes electric generator output yd (t(k+1)), yd (t(k+2)), . . . , yd (tm) at time t(k+1), t(k+2), . . . , tm.

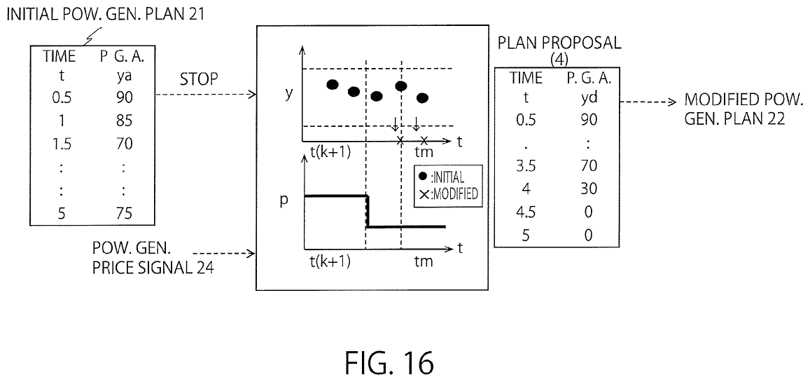

Details of the modified power generation plan (4) are illustrated in FIG. 16. FIG. 16 is another diagram for description of power generation plan development in the case of ΔEg(tk)<0. In FIG. 16, since the power generation price is high in the first half of time t(k+1) to tm and low in the second half of time t(k+1) to tm, the electric generator output is not changed in the first half of time t(k+1) to tm and power generation is stopped in the second half of time t(k+1) to tm. This makes it possible to set the total power generation amount of yd (t(k+1))+yd (t(k+2)), . . . , +yd (tm) in the modified power generation plan (4) to be smaller than the total power generation amount of ya(t(k+1))+ya(t(k+2)), . . . , +ya(tm) in the initial power generation plan 21.

### [C-3-3] Case of ΔEg(Tk)>0

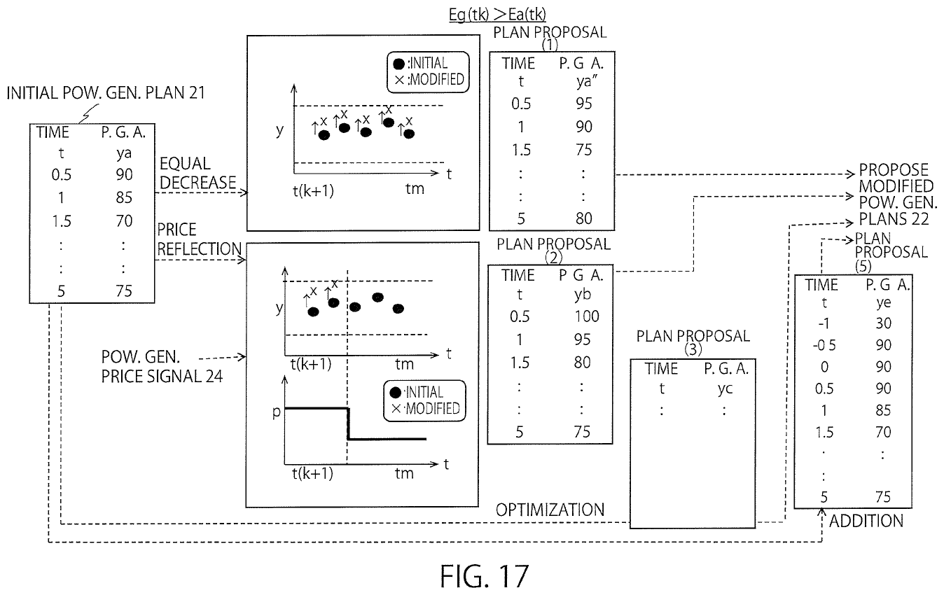

FIG. 17 is a diagram for description of power generation plan development in the case of ΔEg(tk)>0.

In the case of ΔEg(tk)>0, the stored thermal energy amount Eg(tk) is surplus relative to the necessary energy amount Ea(tk). In this case, the power generation plan processor 7 outputs a modified power generation plan (1), a modified power generation plan (2), a modified power generation plan (3), and a modified power generation plan (5) as the modified power generation plans 22. As illustrated in FIG. 17, the plans are also referred to as a plan proposal (1), a plan proposal (2), a plan proposal (3), and a plan proposal (5), respectively.

### <Modified Power Generation Plan (1)>

The power generation plan processor 7 develops the modified power generation plan (1) from the initial power generation plan 21 by equally increasing all electric generator outputs ya in the initial power generation plan 21 to modify the modified power generation plan (1). The modified power generation plan (1) illustrated in FIG. 17 includes electric generator output ya″(t(k+1)), ya″(t(k+2)), . . . , ya″(tm) at time t(k+1), t(k+2), . . . , tm.

For example, in a case in which the initial power generation plan 21 includes 10 electric generator outputs ya(0.5), ya(1), ya(1.5), . . . , ya(5) for 10 times t=0.5, 1, 1.5, . . . , 5, each electric generator output ya″(t) of the modified power generation plan (1) is given by Expression (12) below.

$${ya}^{″} ( t ) = y a ( t ) + \frac{Δ Eg ( tk )}{10} \qquad ( 12 )$$

Specifically, ya″(0.5), ya″(1), ya″(1.5), . . . , ya″(5) are the sums of ya(0.5), ya(1), ya(1.5), . . . , ya(5), respectively, and ΔEg(tk)/10. Since ΔEg(tk) is positive in the case of FIG. 17, ya″(0.5), ya″(1), ya″(1.5), . . . , ya″(5) are larger than ya(0.5), ya(1), ya(1.5), . . . , ya(5), respectively. This makes it possible to set the total power generation amount of ya″(t(k+1))+ya″(t(k+2)), . . . , +ya″(tm) in the modified power generation plan (1) to be larger than the total power generation amount of ya(t(k+1))+ya(t(k+2)), . . . , +ya(tm) in the initial power generation plan 21.

As in the case of ΔEg(tk)=0, the power generation plan processor 7 in the case of ΔEg(tk)>0 may output the initial power generation plan 21 as the modified power generation plan (1) with no change without modifying the initial power generation plan 21. Moreover, the power generation plan processor 7 in the case of ΔEg(tk)>0 may output both the modified power generation plan (1) including ya(t(k+1)), ya(t(k+2)), . . . , ya(tm) and the modified power generation plan (1) including ya″(t(k+1)), ya″(t(k+2)), . . . , ya″(tm).

### <Modified Power Generation Plan (2)>

The power generation plan processor 7 develops the modified power generation plan (2) from the initial power generation plan 21 by modifying the initial power generation plan 21 by using the power generation price signal 24. The modified power generation plan (2) illustrated in FIG. 17 includes electric generator output yb(t(k+1)), yb(t(k+2)), . . . , yb(tm) at time t(k+1), t(k+2), . . . , tm.

The modified power generation plan (2) in the case of ΔEg(tk)>0 can be calculated in the same manner as the modified power generation plan (2) in the case of ΔEg(tk)=0. However, the modified power generation plan (2) in the case of ΔEg(tk)>0 is calculated to satisfy a constraint condition that the necessary energy amount E(tk) (=Ed (tk)) calculated by using Expressions (7) and (8) is equal to the stored thermal energy amount Eg(tk). The constraint condition is expressed by Expression (13) below.

$$Δ Ed ( t k ) = Eg ( tk ) - Ed ( tk ) = 0 \qquad ( 13 )$$

For example, in a case in which the power generation price is high in the first half of time t(k+1) to tm and low in the second half of time t(k+1) to tm (refer to FIG. 17), the electric generator output in the first half of time t(k+1) to tm is increased and the electric generator output in the second half of time t(k+1) to tm is not changed. This makes it possible set the total power generation amount of yb(t(k+1))+yb(t(k+2)), . . . , +yb(tm) in the modified power generation plan (2) to be larger than the total power generation amount of ya(t(k+1))+ya(t(k+2)), . . . , +ya(tm) in the initial power generation plan 21.

### <Modified Power Generation Plan (3)>

The power generation plan processor 7 develops the modified power generation plan (3) from the initial power generation plan 21 by solving an optimization problem with the stored thermal energy amount Eg(tk) to modify the initial power generation plan 21. The modified power generation plan (3) illustrated in FIG. 17 includes electric generator output yc(t(k+1)), yc(t(k+2)), . . . , yc(tm) at time t(k+1), t(k+2), . . . , tm.

The modified power generation plan (3) in the case of ΔEg(tk)>0 can be calculated in the same manner as the modified power generation plan (3) in the case of ΔEg(tk)=0. This makes it possible to set the total power generation amount of yc(t(k+1))+yc(t(k+2)), . . . , +yc(tm) in the modified power generation plan (3) to be larger than the total power generation amount of ya(t(k+1))+ya(t(k+2)), . . . , +ya(tm) in the initial power generation plan 21.

### <Modified Power Generation Plan (5)>

The power generation plan processor 7 develops the modified power generation plan (5) from the initial power generation plan 21 by modifying the initial power generation plan 21 to add power generation at a time when the power generation price p is high. The modified power generation plan (5) illustrated in FIG. 17 includes electric generator output ye(t(k−2)), ye(t(k−1)), ye(t(k)), ye(t(k+1)), ye(t(k+2)), . . . , ye(tm) at time t(k−2), t(k−1), t(k), t(k+1), t(k+2), . . . , tm.

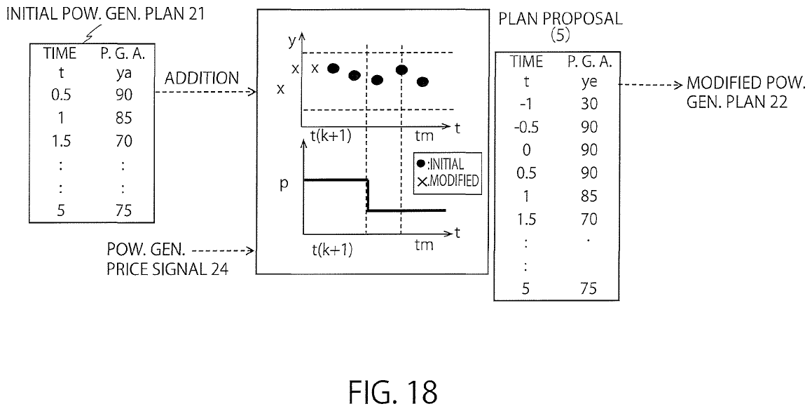

Details of the modified power generation plan (5) are illustrated in FIG. 18. FIG. 18 is another diagram for description of power generation plan development in the case of ΔEg(tk)>0. In FIG. 18, since the power generation price is high in the first half of time t(k+1) to tm and low in the second half of time t(k+1) to tm, the power generation start time is set earlier. Specifically, power generation at time t(k−2) to t(k) is added in the power generation plan. This makes it possible to set the total power generation amount of ye(t(k−2))+ye(t(k−1)), . . . , +ye(tm) in the modified power generation plan (5) to be larger than the total power generation amount of ya(t(k+1))+ya(t(k+2)), . . . , +ya(tm) in the initial power generation plan 21.

Thereafter, the power generation plan processor 7 determine and outputs the execution power generation plan 25 in accordance with the execution permission signal 23 that selects one of the one or more modified power generation plans 22. The power generation plan processor 7 outputs the power generation amount (electric generator output) at each time in the execution power generation plan 25 to the power generation controller 8 as the power generation command signal 17 in accordance with time elapse.

The present embodiment makes it possible to accurately calculate the stored thermal energy amount Eg(tk) through the above-described processing. The above-described one or more temperature meters 6 of the present embodiment are appropriately disposed to perform such processing. Moreover, the present embodiment makes it possible to accurately calculate an appropriate modified power generation plan 22 by modifying the initial power generation plan 21 with Eg(tk).

### [D] First Modification

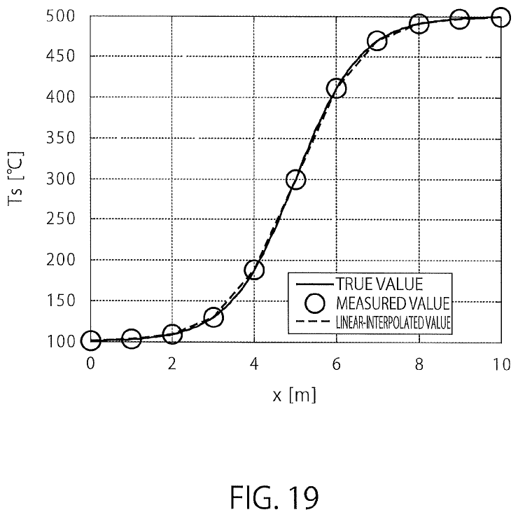

FIG. 19 is a graph for description of interpolation processing (linear interpolation) of a first modification of the first embodiment.

In the above-described embodiment, for example, 20 to 100 temperature meters 6 are installed because it is important to accurately obtain the internal temperature of the heat storage 2. However, use of such a large number of temperature meters 6 have the following problems. Firstly, significant work is needed to install the temperature meters 6. Secondly, significant work is needed to calibrate the temperature meters 6. Thirdly, significant work is needed for maintenance in a case in which the temperature meters 6 are used for a long duration. Fourthly, cost for preparing the temperature meters 6 increases with the number of temperature meters 6.

To avoid these problems, the present modification performs interpolation processing of the internal temperature to decrease the number of temperature meters 6 to be installed. The number of temperature meters 6 to be installed in the present modification is, for example, 15.

In FIG. 19, the horizontal axis represents the position x of the heat storage 2, and it is assumed that the heat transfer fluid 13a at low temperature flows in from the left side and flows toward the right side and the heat transfer fluid 13b at high temperature flows out from the right side. Specifically, the length of the heat storage 2 is 10 [m] in the illustrated example. The vertical axis represents the internal temperature of the heat storage 2. In FIG. 19, for example, the internal temperature of the heat storage 2 is 180 [° C.] at 4 [m] from the heat transfer fluid entrance.

In FIG. 19, the solid line represents the true value of the internal temperature of the heat storage 2. Each circle (O) represents a measured temperature indicated by the temperature measurement signal 16 output from a temperature meter 6. In this example, 11 temperature meters 6 are installed at the interval of 1 [m] from the left side to the right side. The dashed line represents a value obtained by linearly interpolating the measured temperatures of the temperature measurement signals 16. It can be understood from FIG. 19 that a value that substantially matches the true value can be calculated through linear interpolation by using about 11 temperature measurement signals 16. This linear interpolation calculation may be executed in the power generation plan processor 7.

The present modification makes it possible to accurately calculate the internal temperature of the heat storage 2 by using about 15 temperature meters 6 and using a value obtained by linearly interpolating the measured temperatures of the temperature measurement signals 16. As a result, the stored thermal energy amount Eg(tk) can be accurately calculated.

### [E] Second Modification

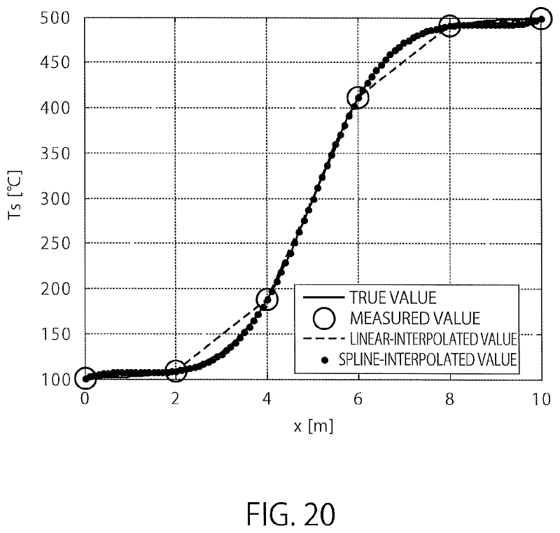

FIG. 20 is a graph for description of interpolation processing (spline interpolation) of a second modification of the first embodiment.

In the above-described first modification, for example, about 15 temperature meters 6 are used to accurately determine the internal temperature of the heat storage 2. In the present modification, the number of temperature meters 6 to be installed is further decreased. The number of temperature meters 6 to be installed in the present modification is, for example, 10.

The vertical and horizontal axes in FIG. 20 are the same as in the case of FIG. 19. The solid line represents the true value of the internal temperature of the heat storage 2. A circle (O) represents a measured temperature indicated by the temperature measurement signal 16 output from a temperature meter 6. In this example, six temperature meters 6 are installed at the interval of 2 [m] from the left side to the right side. The dashed line represents a value obtained by linearly interpolating the measured temperatures of the temperature measurement signals 16. A dot (small black point) represents a value obtained by spline-interpolating the measured temperatures of the temperature measurement signals 16. It can be observed that the value of linear interpolation has large difference from the true value at some places but the value of spline interpolation is substantially equal to the true value. This spline interpolation calculation may be executed in the power generation plan processor 7.

The present modification makes it possible to more accurately calculate the internal temperature of the heat storage 2 by using about 10 temperature meters 6 and using a value obtained by spline-interpolating the measured temperatures of the temperature measurement signals 16. As a result, the stored thermal energy amount Eg(tk) can be more accurately calculated. However, the linear interpolation of the first modification typically can be more easily performed than the spline interpolation of the second modification.

As described above, the heat storage power generation system of the present embodiment measures the internal temperature of the heat storage 2 with one or more temperature meters 6 and controls power generation performed by the power generator 3 based on the internal temperature measured by the temperature meters 6. For example, the heat storage power generation system of the present embodiment determines the function Ts(xa, tk) representing distribution of the internal temperature by using the internal temperature measured by the temperature meters 6, calculates the stored thermal energy amount Eg(tk) by using the function Ts(xa, tk), develops a power generation plan by using the stored thermal energy amount Eg(tk), and controls power generation based on the power generation plan. Accordingly, the present embodiment makes it possible to suitably operate the heat storage 2 and the power generator 3 of the heat storage power generation system.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

1. (canceled)

2. A heat storage power generation system comprising:
a heater configured to heat first heat transfer fluid;
a heat storage including a heat storage material heated by the first heat transfer fluid, and configured to heat second heat transfer fluid with heat stored in the heat storage material;
a power generator configured to generate electric power by using the second heat transfer fluid;
one or more temperature meters configured to measure internal temperature of the heat storage;
a power generation controller configured to control power generation performed by the power generator, based on the internal temperature measured by the temperature meters; and
a power generation plan processor configured to develop a power generation plan for the power generator, based on the internal temperature measured by the temperature meters,
wherein the power generation controller controls the power generation performed by the power generator, based on the power generation plan.

3. The system of claim 2, wherein the power generation plan processor outputs, as the power generation plan, a modified power generation plan developed by modifying an initial power generation plan.

4. The system of claim 3, wherein the power generation plan processor outputs, as the power generation plan, an execution power generation plan selected from among a plurality of modified power generation plans.

5. The system of claim 2, wherein the power generation plan processor determines distribution of the internal temperature as a function of place and time based on the internal temperature measured by the temperature meters, and develops the power generation plan based on the distribution of the internal temperature.

6. The system of claim 5, wherein the power generation plan processor determines the distribution of the internal temperature by using linear interpolation.

7. The system of claim 5, wherein the power generation plan processor determines the distribution of the internal temperature by using spline interpolation.

8. The system of claim 5, wherein the power generation plan processor calculates, based on the distribution of the internal temperature, a stored thermal energy amount stored in the heat storage and usable for the power generation from a predetermined time to a power generation end time in a heat releasing mode, and develops the power generation plan based on the stored thermal energy amount.

9. The system of claim 8, wherein the power generation plan processor outputs, as the power generation plan, an initial power generation plan when the stored thermal energy amount is equal to a necessary energy amount.

10. The system of claim 8, wherein the power generation plan processor outputs, as the power generation plan, a modified power generation plan developed by modifying an initial power generation plan to decrease a total amount of power generation by the power generator, when the stored thermal energy amount is smaller than a necessary energy amount.

11. The system of claim 8, wherein the power generation plan processor outputs, as the power generation plan, a modified power generation plan developed by modifying an initial power generation plan to increase a total amount of power generation by the power generator, when the stored thermal energy amount is larger than a necessary energy amount.

12. The system of claim 8, wherein the power generation plan processor develops the power generation plan, based on the stored thermal energy amount and a power generation price.

13. The system of claim 8, wherein the power generation plan processor develops the power generation plan by solving an optimization problem by using the stored thermal energy amount.

14. The system of claim 2, further comprising:
a first air sender configured to cause the first heat transfer fluid to circulate between the heater and the heat storage;
a second air sender configured to cause the second heat transfer fluid to circulate between the heat storage and the power generator; and
an air-sending controller configured to control operation of the first and second air senders.

15. A power generation control system configured to control a heat storage power generation system including:
a heater configured to heat first heat transfer fluid;
a heat storage including a heat storage material heated by the first heat transfer fluid, and configured to heat second heat transfer fluid with heat stored in the heat storage material; and
a power generator configured to generate electric power by using the second heat transfer fluid,
the power generation control system comprising:
one or more temperature meters configured to measure internal temperature of the heat storage; and
a power generation controller configured to control power generation performed by the power generator, based on the internal temperature measured by the temperature meters.
